(19) United States
(12) Patent Application Publication
(10) Pub. No.: US 2006/0136321 A1
(43) Pub. Date: Jun. 22, 2006

(54) Bid methods and systems for an auction website

(75) Inventors: Chih-Hao Hsu, Taipei (TW); Wen-Ju Huang, Taipei County (TW); Yi-Kuan Huang, Taipei City (TW)

Correspondence Address: BIRCH STEWART KOLASCH & BIRCH, PO BOX 747, FALLS CHURCH, VA, 22040-0747, US

(73) Assignee: Institute for Information Industry, Taipei (TW)

(21) Appl. No.: 11/139,615

(22) Filed: May 31, 2005

(30) Foreign Application Priority Data
Dec. 20, 2004 (CN) 200410010518X

(51) Int. Cl. G06Q 40/00

(52) U.S. Cl. 705/37

(57) ABSTRACT

A bid method for an auction website is provided. The auction items are searched according to search parameters to acquire candidate items satisfying the search parameters. Item factors and corresponding weights are then acquired. Purchase value for each candidate item is calculated according to the item factors and the weights. The candidate items can be sorted according to the purchase values and listed for further bidding.

### BACKGROUND

The invention relates to electronic commerce methods, and in particular to bid methods and systems for a bid website.

With the popularization of networks, such as the Internet, commercial activities conducted thereon increase rapidly. Auction websites, frequently used in a network may comprise multiple items offered by different venders. Buyers can purchase the offered items through bidding over the network. With the convenience and the universality of networked electronic commerce, auction websites occupy a considerable portion of electronic commerce. Thus, auction website-related technology has become increasingly important.

Conventional auction website procedure is described as following. For example, one buyer may log into an auction website. The buyer then enters search parameters according to options provided by the auction website. The auction website searches offered items therein according to the entered parameters to acquire suitable items, which may appear on a list for selection. The buyer can select from the list and set the highest price thereof. A bid of the auction website then executes competition for the buyer based on the item list and the set price.

The conventional procedure has some drawbacks. Primarily, buyers can only set the highest price for one item. Additionally, the conventional procedure only focuses on item prices, while real value of an item is reflected not only by the price, but also by factors, such as delivery location, delivery methods, conditions of item, or auction end time. Some methods and systems can execute bid for multiple items, but all search parameters must be input or controlled manually, causing inconvenience.

Thus, systematic bid methods and systems to generate candidate item lists for buyers and reduce manual operations are desirable.

An exemplary embodiment of a bid method for an auction website of multiple items is provided. The offered items are searched according to search parameters to acquire candidate items suitable the search parameters. Contributing factors and corresponding weights are then acquired. Purchase value for each candidate item is calculated according to the factors and weights. Finally, the candidate items are sorted according to the purchase values.

### DESCRIPTION OF THE DRAWINGS

The invention can be more fully understood by reading the subsequent detailed description and examples with references made to the accompanying drawings, wherein:

FIG. 1 is a flowchart of an embodiment of a bid method for an auction website.

FIG. 2 is a diagram of a machine-readable storage medium for storing a computer program providing a bid method for an auction website.

FIG. 3 is a diagram of an exemplary embodiment of a bid method for an auction website.

FIG. 4 is a diagram of an exemplary embodiment of a bid method for an auction website.

FIG. 5 is a diagram of an exemplary embodiment of a bid method for an auction website.

### DESCRIPTION

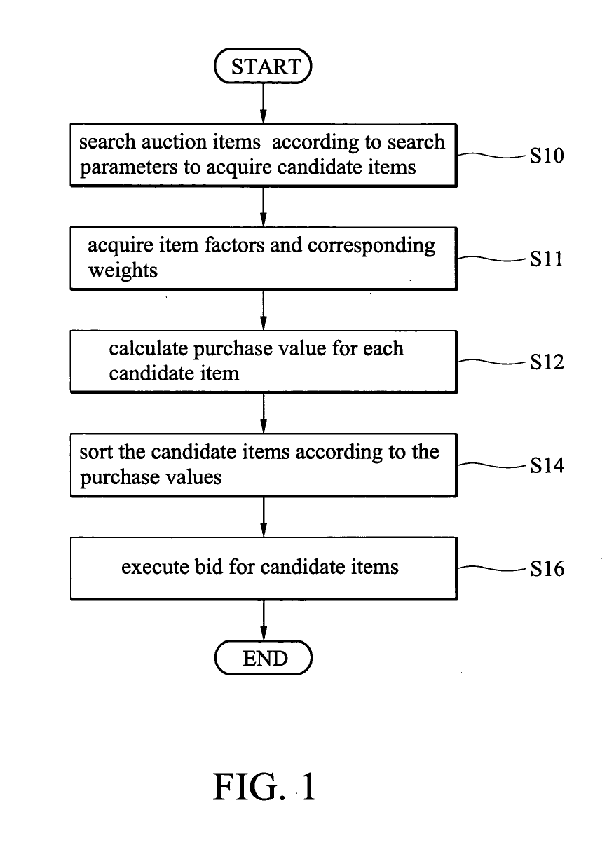

FIG. 1 is a flowchart of an embodiment of a bid method for an auction website. Auction items are searched (step S10) according to search parameters to acquire candidate items suitable the search parameters. Item factors and corresponding weights are then acquired (step S11). Item factors and/or weights are generated by manual input or by computer systems. Item factors can be defined according to aspects of the purchase beyond price alone.

Purchase value for each candidate item is calculated according to the item factors and the weights (step S12). The candidate items are then sorted according to the purchase values (step S14). Thereafter, bid can be executed for one or more candidate items according to the sorting result (step S16).

As described, methods provided can execute bid for multiple objects in an auction website. Buyers can enter search parameters based on options in the auction website and input item factors and corresponding weights to execute bid effectively, increasing flexibility of auction websites.

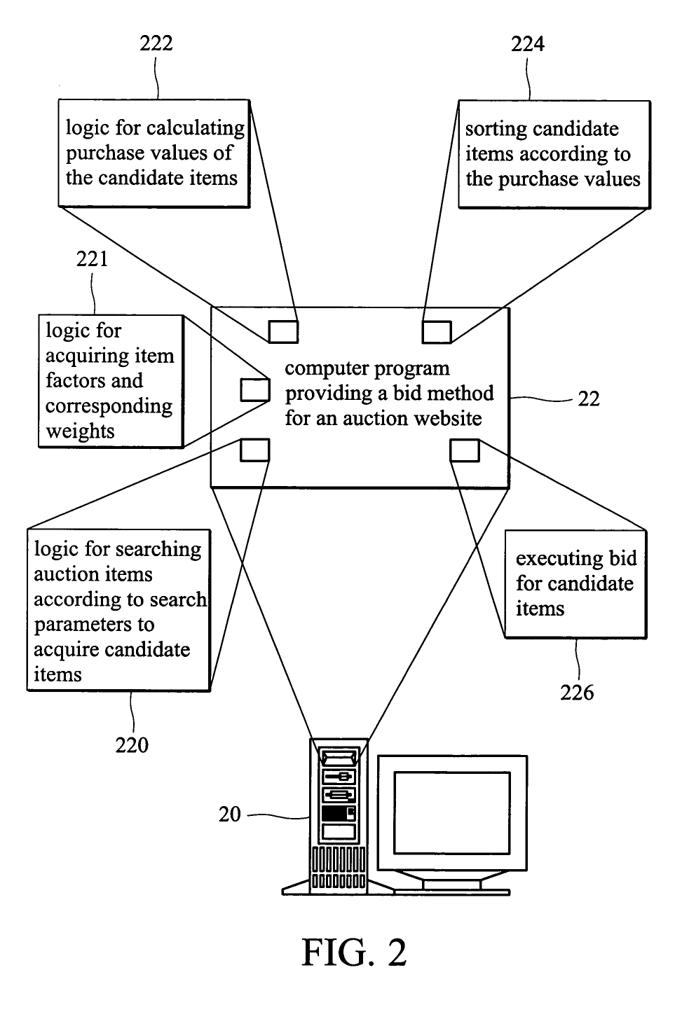

FIG. 2 is a diagram of a machine-readable storage medium for storing a computer program providing a bid method for an auction website. A machine-readable storage medium 20 storing a computer program 22 providing a bid method for an auction website is disclosed. The computer program 22 mainly comprises logic searching auction items according to search parameters to acquire candidate items 220, acquiring item factors and corresponding weights 221, calculating purchase values of the candidate items 222, sorting candidate items according to the purchase values 224, and executing bid for candidate items 226.

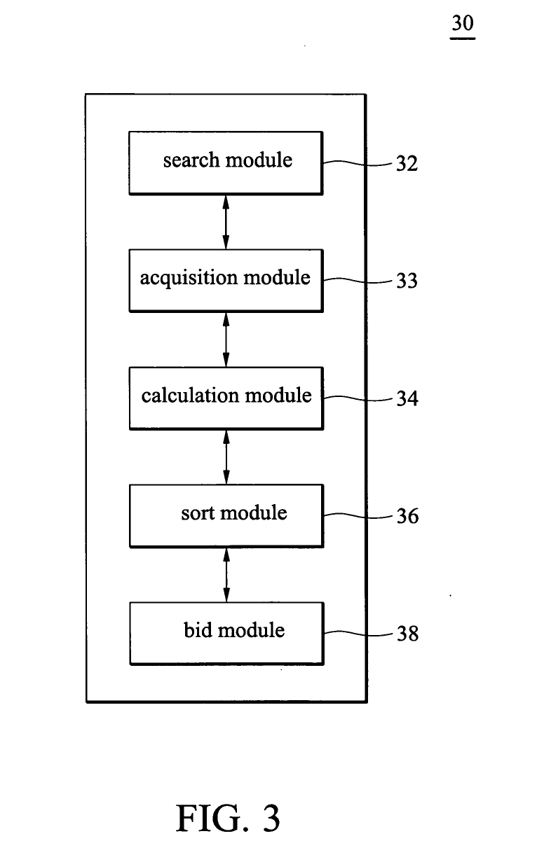

FIG. 3 is a diagram of an exemplary embodiment of a bid method for an auction website. A bid system 30 for an auction website of multiple auction items comprises a search module 32, an acquisition module 33, a calculation module 34, a sort module 36, and a bid module 38.

The search module 32 searches the auction items according to search parameters to acquire candidate items suitable the search parameters. The acquisition module 33 acquires item factors and corresponding weights. The item factors and/or corresponding weights can be generated by manual input or computer systems. The item factors can be defined according to states of aspects of the purchase beyond price alone.

The calculation module 34 calculates purchase value for each candidate item according to the item factors and the weights. The sort module 36 sorts the candidate items according to the calculated purchase values. The bid module 38 executes bid for one or more items according to the sorting result.

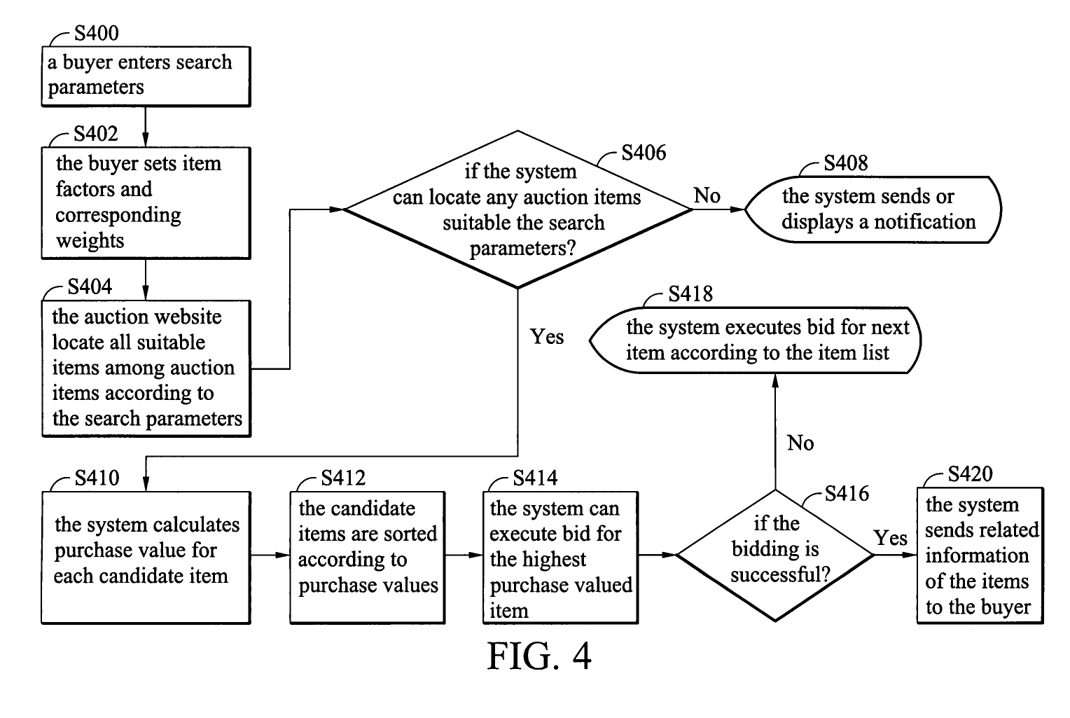

FIG. 4 is a diagram of an exemplary embodiment of a bid method for an auction website. In the exemplary embodiment, the provided bid methods are applied to an auction website. A buyer enters search parameters (step S400). The buyer then sets item factors and corresponding weights according to actual requirements (step S402). The auction website provides a system to locate all suitable items among auction items according to the search parameters (step S404).

In step S404, if the system cannot locate any auction items suitable the search parameters (step S406), the system sends or displays a notification thereof (step S408) If the system locates auction items suitable the search parameters (step S406), the system calculates purchase value for each candidate item according to the item factors and the corresponding weights (step S410).

The candidate items are then sorted according to their purchase values (step S412). The sorting result may be listed and displayed to the buyer. Thereafter, the system can execute bid for the highest purchase valued item according to the sorting result (step S414). It is then determined if the bidding is successful (step S416), and, if so, the system sends related information of the items to the buyer (step S420). If the bidding is not successful, the system executes bid for the next highest purchase valued item according to the item list (step s418).

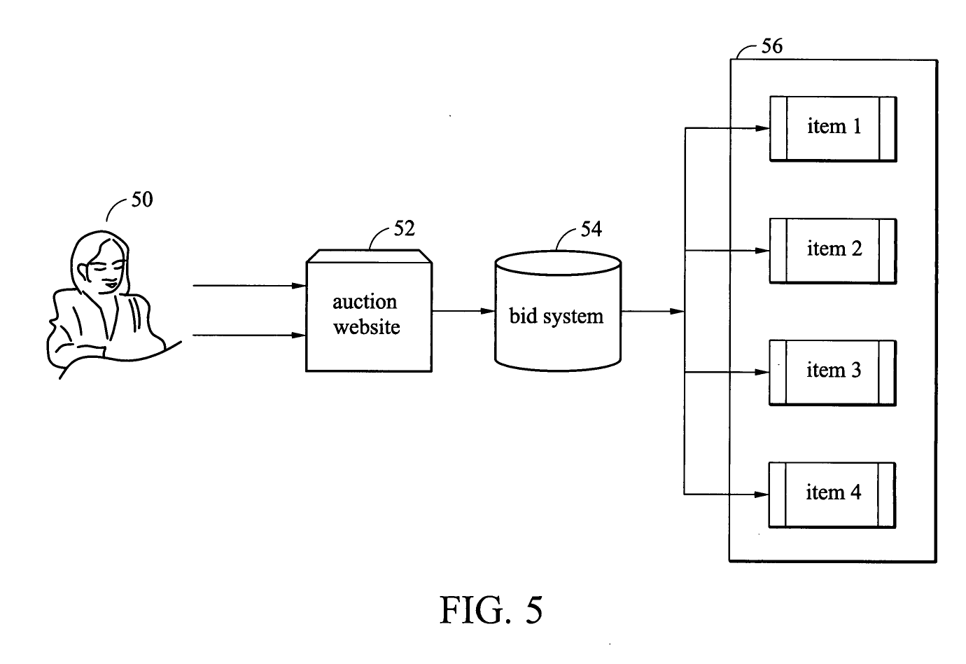

FIG. 5 is a diagram of an exemplary embodiment of a bid method for an auction website. In the exemplary embodiment, the provided bid methods are applied to an auction website. A buyer 50 logs onto an auction website 52. The buyer 50 then enters search parameters and corresponding weights. A bid system 54 executes the described steps. A candidate item list 56 is generated and bid can be executed accordingly.

Methods and systems of the present disclosure, or certain aspects or portions of embodiments thereof, may take the form of program code (i.e., instructions) embodied in media, such as floppy diskettes, CD-ROMS, hard drives, firmware, or any other machine-readable storage medium, wherein, when the program code is loaded into and executed by a machine, such as a computer, the machine becomes an apparatus for practicing and embodiment of the disclosure. The methods and apparatus of the present disclosure may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing and embodiment of the disclosure. When implemented on a general-purpose processor, the program code combines with the processor to provide a unique apparatus that operates analogously to specific logic circuits.

While the invention has been described by way of example and in terms of preferred embodiment, it is to be understood that the invention is not limited thereto. Those skilled in the technology can still make various alterations and modifications without departing from the scope and spirit of this invention. Therefore, the scope of the present invention shall be defined and protected by the following claims and their equivalents.

What is claimed is:

1. A bid method for an auction website, wherein the auction website provides at least one item for sale, the method comprising:
searching the items according to at least one search parameter to acquire at least one candidate item satisfying the search parameters;
acquiring at least one item factor and corresponding weight;
calculating purchase value for each candidate item according to the item factors and weights; and
sorting the candidate items according to the purchase values.

2. The bid method for an auction website as claimed in claim 1, wherein the item factors are defined according to conditions of the items, and the conditions comprise aspects of the purchase beyond price alone.

3. The bid method for an auction website as claimed in claim 1, wherein the item factors and/or the weights are generated by manual input.

4. The bid method for an auction website as claimed in claim 1, wherein the item factors and/or the weights are generated by computer systems.

5. The bid method for an auction website as claimed in claim 1, further comprising comparing prices for one or more candidate items according to the sorting result.

6. A bid system for an auction website, wherein the website provides at least one auction item for sale, comprising:
a search module, searching the auction items according to at least one search parameter to acquire at least one candidate item satisfying the search parameters;
an acquisition module, coupled to the search module, acquiring at least one item factor and corresponding weight;
a calculation module, coupled to the acquisition module, calculating purchase value for each candidate item according to the item factors and weights; and
a sort module, coupled to the calculation module, sorting the candidate items according to the purchase values.

7. The bid system for an auction website as claimed in claim 6, wherein the item factors are defined according to conditions of the items, and the conditions comprise aspects of the purchase beyond price alone.

8. The bid system for an auction website as claimed in claim 6, wherein the item factors and/or the weights are generated by manual input.

9. The bid system for an auction website as claimed in claim 6, wherein the item factors and/or the weights are generated by computer systems.

10. The bid system for an auction website as claimed in claim 6, further comprising a bid module, coupled to the sort module, comparing prices for one or more candidate items according to the sorting result.
